(19) United States
(12) Patent Application Publication
(10) Pub. No.: US 2014/0135952 A1
(43) Pub. Date: May 15, 2014

(54) HOME NETWORK SYSTEM

(71) Applicant: SAMSUNG ELECTRONICS CO., LTD., Suwon-si (KR)

(72) Inventor: Masakazu MAEHARA, Yokohama-si (JP)

(73) Assignee: SAMSUNG ELECTRONICS CO., LTD., Suwon-si (KR)

(21) Appl. No.: 14/081,285

(22) Filed: Nov. 15, 2013

(30) Foreign Application Priority Data
Nov. 15, 2012 (JP) 2012-251659
Aug. 13, 2013 (KR) 10-2013-0096111

(51) Int. Cl. G05B 15/02

(52) U.S. Cl. CPC G05B 15/02
USPC 700/90

(57) ABSTRACT

Disclosed is a home network control apparatus for controlling a plurality of home devices. The home network control apparatus includes a plurality of home device agents respectively corresponding to the plurality of home devices, and an agent manager which is configured to transmit device information obtained from the plurality of home devices to each of the plurality of home device agents, output a control command obtained from the plurality of home device agents to the plurality of home devices, calculate a pay value according to a state variation obtained from the plurality of home devices, the state variation being based on the device information, and update a value function of the plurality of home device agents by using the pay value as a parameter, the value function being used to generate the control command.

### CROSS-REFERENCE TO RELATED APPLICATIONS

This application claims the benefit of Japanese Patent Application No. 2012-0251659, filed on Nov. 15, 2012, in the Japanese Patent Office and Korean Patent Application No. 10-2013-0096111, filed on Aug. 13, 2013, in the Korean Intellectual Property Office, the disclosures of which are incorporated herein in their entirety by reference.

### BACKGROUND

1. Field

One or more exemplary embodiments relate to a home network system in which a master device learns how to control a plurality of home devices when the master device is connected to the plurality of home devices via a communication network.

2. Description of the Related Art

In an intelligent house having a plurality of sensors, as shown in patent document WO2005/083531, a conventional home network system includes at least one home device and a device controller (agent) which controls the at least one home device. In detail, the device controller is configured to specify a sensor which has a high correlation with the home device with respect to the control of a home device, and to optimize control of the home device by learning how to control the specified sensor using a neural network.

However, the home network system of patent document WO2005/083531 includes the device controller which specifies a sensor having a high correlation with a home device which is required so that the home device may optimally control the random home device. Thus, the home network system needs to extract a sensor which has a high correlation with each home device, and needs to store operation-process time-varying data for the extraction, thereby lowering efficiency.

Furthermore, in an environment where there are multiple kinds of home devices, it may be difficult to extract a sensor which has a high correlation with each of the plurality of home devices. In addition, all sensors may have a correlation with each home device, and thus extracting and controlling only one sensor for use in controlling all of the home devices may not be sufficient for optimal control of the home devices or the control of the home device may be misplaced to the specific sensor.

Furthermore, the device controller, which is configured as a single agent, concentrates on teaching the home device control operations, thus it is difficult to generate a virtual model of the home device from another device controller, and the fault-tolerance of a home network system is low.

### SUMMARY

One or more exemplary embodiments include a home network system which controls a plurality of home devices autonomously and in a distributed manner, allows optimal control of a plurality of home devices by resolving inconvenience according to extraction of a sensor associated with each home device, and easily moves a virtual model of a home device to another master device.

Additional aspects will be set forth in part in the description which follows and, in part, will be apparent from the description, or may be learned by practice of the presented exemplary embodiments.

According to an exemplary embodiment, a home network control apparatus configured to control a plurality of home devices includes: a plurality of home device agents respectively corresponding to the plurality of home devices; and an agent manager which is configured to transmit device information obtained from the plurality of home devices to each of the plurality of home device agents, output a control command obtained from the plurality of home device agents to the plurality of home devices, calculate a pay value according to a state variation obtained from the plurality of home devices, the state variation being based on the device information, and update a value function of the plurality of home device agents by using the pay value as a parameter.

The home network control apparatus may further include an agent generator configured to generate the plurality of home device agents respectively corresponding to the plurality of home devices by using profile information of the plurality of respective home devices.

The agent manager may be configured to calculate the pay value by using a power consumption difference as the state variation obtained from the plurality of home devices, and update the value function of the plurality of home device agents to minimize power consumption in the plurality of home devices by using the pay value as a parameter.

According to another exemplary embodiment, a home network system connected to a plurality of home devices which implement respective standardized protocols via a communication network, includes: a master device which controls the plurality of home devices, wherein the master device includes: a plurality of home device agents respectively corresponding to the plurality of home devices; and an agent manager which is configured to transmit device information obtained from the plurality of home devices to each of the plurality of home device agents, output a control command obtained from the plurality of home device agents to the plurality of home devices, calculate a pay value according to a state variation obtained from the plurality of home devices, the state variation being based on the device information, and update a value function of the plurality of home device agents by using the pay value as a parameter, the value function being used to generate the control command.

The home network system may further include an agent generator configured to generate the plurality of home device agents respectively corresponding to the plurality of home devices by using profile information of the plurality of respective home devices.

The agent manager may be configured to calculate the pay value by using a power consumption difference as the state variation obtained from the plurality of home devices, and update the value function of the plurality of home device agents to minimize power consumption in the plurality of home devices by using the pay value as a parameter.

The master device may be implemented as one of the plurality of home devices.

According to another exemplary embodiment, a non-transitory computer readable recording medium having recorded thereon a home device control program which is connected to a plurality of home devices which implement respective standardized protocols and is used in a home network system including a master device that controls the plurality of home devices, includes: a plurality of home device agents respectively corresponding to the plurality of home devices; and an agent manager which is configured to transmit device information obtained from the plurality of home devices to each of the plurality of home device agents, output a control command obtained from the plurality of home device agents to the plurality of home devices, calculate a pay value according to a state variation obtained from the plurality of home devices, the state variation being based on the device information, and update a value function of the plurality of home device agents by using the pay value as a parameter, the value function being used to generate the control command.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a diagram illustrating a home network system, according to an exemplary embodiment;

FIG. 2 is a diagram illustrating transmission of information from a plurality of home devices to a master device, according to an exemplary embodiment;

FIG. 3 is a diagram illustrating control of a plurality of home devices by a master device, according to an exemplary embodiment;

FIG. 4 is a block diagram illustrating the function of a master device, according to an exemplary embodiment;

FIG. 5 is a diagram illustrating an input and an output to each home device agent, according to an exemplary embodiment;

FIG. 6 is a flowchart illustrating an order of control of a master device, according to an exemplary embodiment;

FIG. 7 is a flowchart illustrating a simple model, according to an exemplary embodiment;

FIG. 8 is a diagram illustrating an operation when obtaining state change information in the model of FIG. 7;

FIG. 9 is a diagram illustrating an operation when controlling each home device in the model of FIG. 7; and

FIG. 10 is a diagram illustrating an operation when obtaining power consumption information from each home device in the model of FIG. 7.

### DETAILED DESCRIPTION

Reference will now be made in detail to exemplary embodiments, examples of which are illustrated in the accompanying drawings, wherein like reference numerals refer to the like elements throughout. In this regard, the present exemplary embodiments may have different forms and should not be construed as being limited to the descriptions set forth herein. Accordingly, the exemplary embodiments are merely described below, by referring to the figures, to explain aspects of the present disclosure.

Hereinafter, a home network system according to one or more exemplary embodiments will be described with reference to the attached drawings.

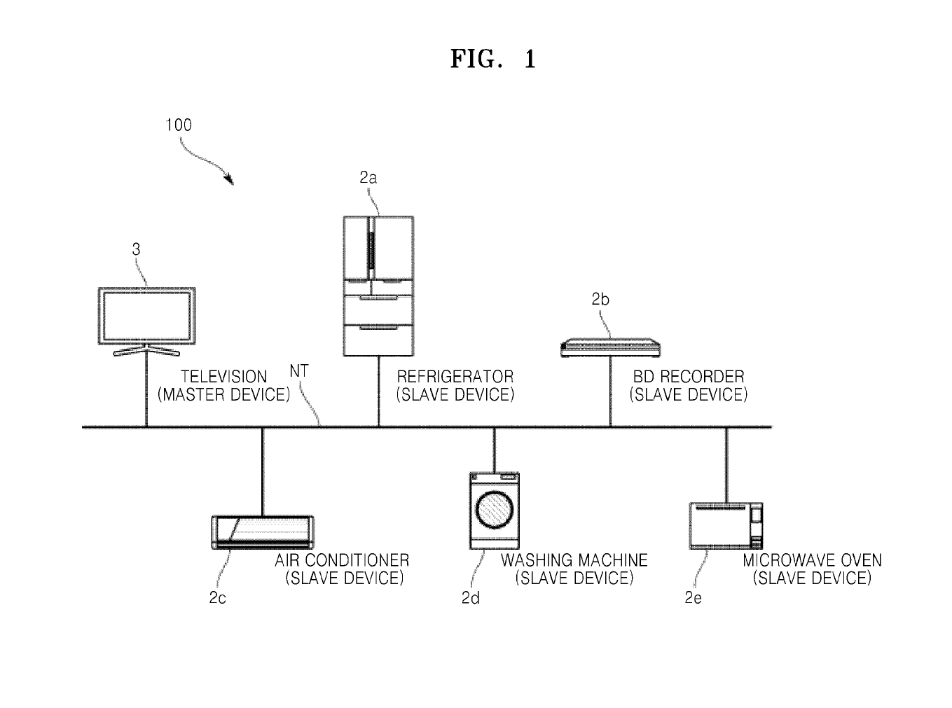

A home network system 100 according to an exemplary embodiment is connected to a plurality of home devices 2a to 2e via a communication network (NT), and includes a master device 3 which controls the plurality of home devices 2a to 2e, as illustrated in FIGS. 1 to 3.

The plurality of home devices 2a to 2e may communicate via respective standardized communication protocols such as Echonet, Zigbee, and UPnP. Furthermore, the plurality of home devices 2a to 2e includes a refrigerator 2a, a Blu-ray Disc (BD) recorder 2b, an air conditioner 2c, a washing machine 2d, and a microwave oven 2e, according to the present exemplary embodiment. Furthermore, the home devices may also include a television, a fan heater, an air cleaner, and a lighting system, or many other types of devices, and are not limited to the examples shown in FIGS. 1 to 3.

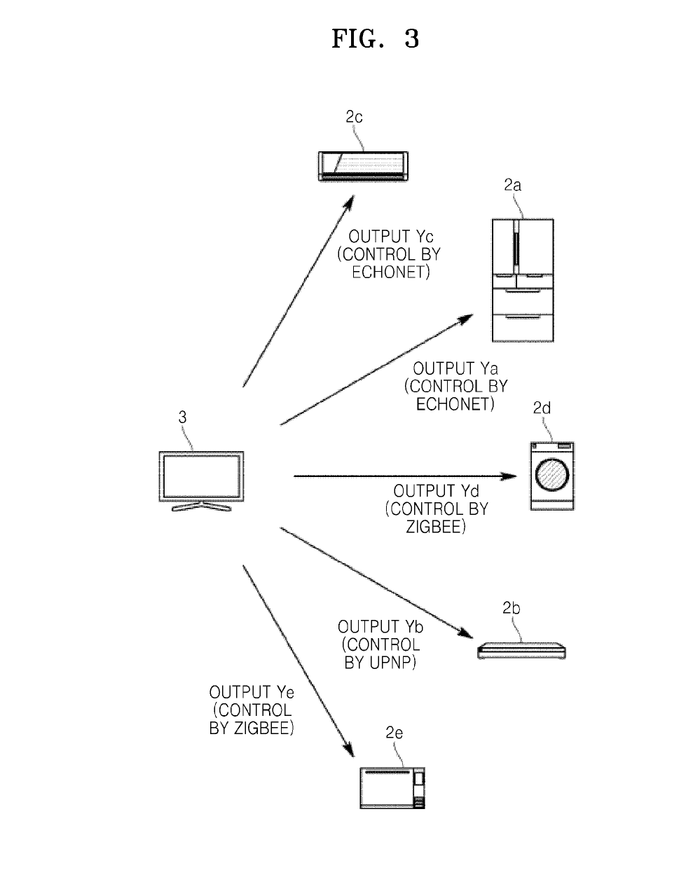

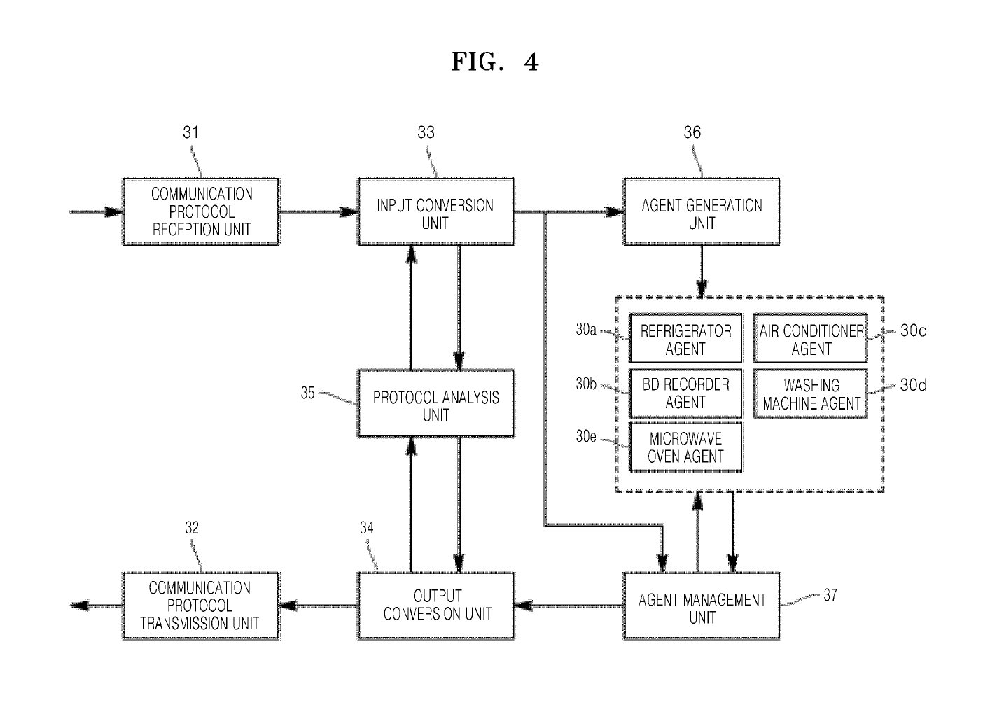

The master device 3 may communicate via the communication protocols (e.g., Echonet, Zigbee, UPnP, etc.) with the plurality of home devices 2a to 2e as illustrated in FIG. 3, which are connected via the communication network (NT). The master device may be a computer including a central processing unit (CPU), a memory, and a communication interface. Furthermore, the master device 3 operates the CPU or a peripheral device based on a program stored in a predetermined area of the memory, and thereby may function as a communication protocol reception unit 31, a communication protocol transmission unit 32, an input conversion unit 33, an output conversion unit 34, a protocol analysis unit 35, an agent generation unit 36 (e.g., agent generator), or an agent management unit 37 (e.g., agent manager) of FIG. 4.

The communication protocol reception unit 31 receives input protocols Xa to Xe respectively from the plurality of home devices 2a to 2e, and the communication protocol transmission unit 32 transmits output protocols Ya to Ye respectively to the plurality of home devices 2a to 2e.

The input conversion unit 33 converts input protocols Xa to Xe received by the communication protocol reception unit 31 into agent input values by using the protocol analysis unit 35, and the output conversion unit 34 converts output values such as a control command into output protocols Ya to Ye by using the protocol analysis unit 35 and outputs the converted output protocols Ya to Ye to the communication protocol transmission unit 32.

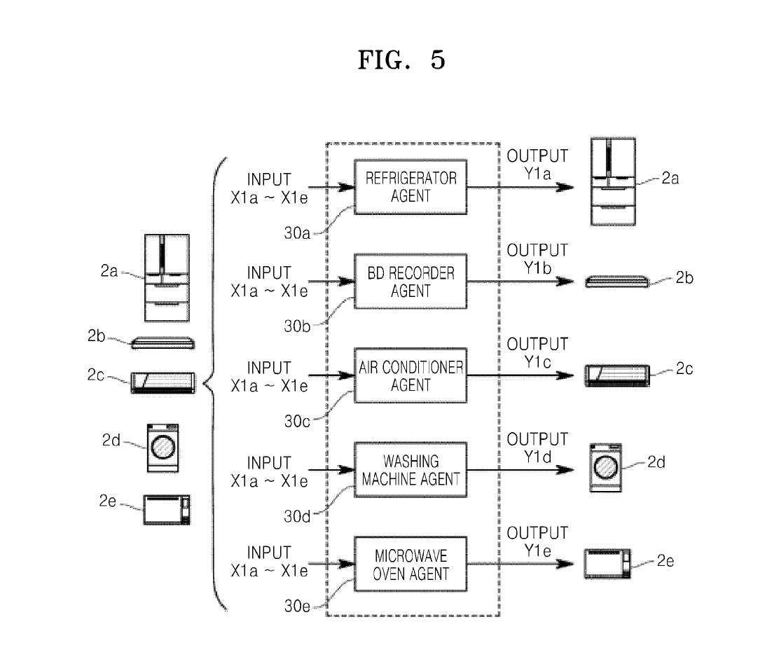

The protocol analysis unit 35 converts the input protocols Xa to Xe into agent input values X1a to X1e (later shown in FIG. 5) and converts output values such as the control command into output protocols Ya to Ye (later shown in FIG. 5).

Referring to FIG. 4, the agent generation unit 36 generates a plurality of home device agents 30a to 30e, which are analysis models respectively corresponding to the plurality of home devices 2a to 2e, within a virtual space which is set within an internal memory of the master device 3.

The agent management unit 37 assigns (see FIG. 5) agent input values X1a to X1e to the plurality of home device agents 30a to 30e and outputs control commands Y1a to Y1e to the plurality of home devices 2a to 2e. The agent input values X1a to X1e indicate device information (e.g., a state variation) of the plurality of home devices 2a to 2e, which is obtained from the plurality of home devices 2a to 2e, for each of the plurality of home device agents 30a to 30e, and the control commands Y1a to Y1e are obtained from the plurality of home device agents 30a to 30e. As a result of the inputting and the outputting, the agent management unit 37 calculates a pay value based on the state variation obtained from each of the plurality of home devices 2a to 2e and updates the value function of the plurality of home device agents 30a to 30e by using the pay value as a parameter. Further, the agent management unit 37 controls the study of the plurality of home devices 2a to 2e using a reinforcement learning operation.

In the reinforcement learning operation (the value function), a learning method, which is applicable to the continuous state space and behavior space, may be used.

The agent management unit 37 calculates the pay value by using the difference in the power consumption as a state variation of home device obtained from the plurality of home devices 2a to 2e, and updates the value function of the plurality of home device agents 30a to 30e to minimize the power consumption in the plurality of home devices 2a to 2e by using the pay value as the parameter. It is understood that the agent management unit 37 may calculate other types of pay values and may update the value function in other ways.

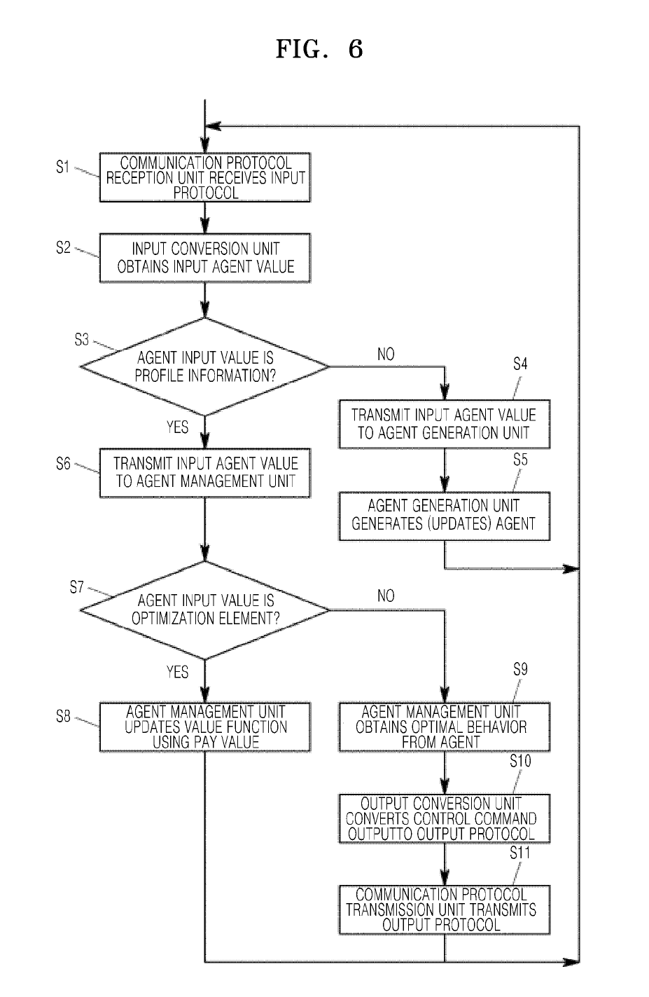

Hereinafter, the control order of the plurality of home devices 2a to 2e by the master device 3 will be described with reference to FIG. 6.

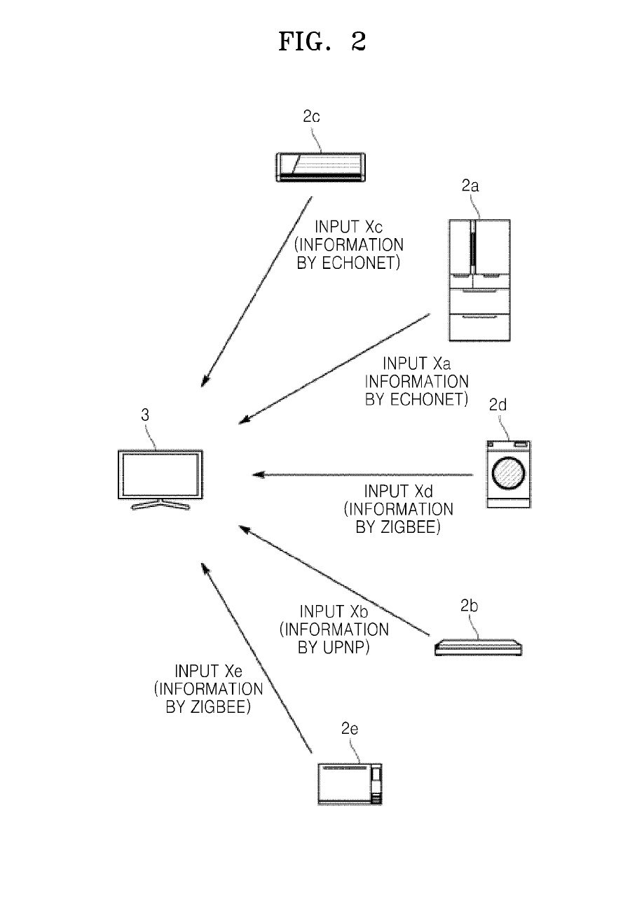

The communication protocol reception unit 31 of the master device 3 receives input protocols Xa to Xe from the plurality of home devices 2a to 2e (operation S1), which are slave devices (see FIG. 2). The input protocols Xa to Xe, which are received by the communication protocol reception unit 31, are transmitted to the input conversion unit 33.

Next, the input conversion unit 33 obtains agent input values X1a to X1e from input protocols Xa to Xe (operation S2) by using the protocol analysis unit 35. The input conversion unit 33 determines whether the agent input values X1a to X1e are profile information of home devices 2a to 2e or state change information related to the state change of the home devices (operation S3). If the agent input values X1a to X1e are profile information of the home devices 2a to 2e, the input conversion unit 33 transmits the agent input values X1a to X1e to the agent generation unit 36 (operation S4).

The agent generation unit 36, which receives the agent input values X1a to X1e indicating profile information, generates home device agents 30a to 30e, which are virtual models of the home devices 2a to 2e, based on the profile information (operation S5). Furthermore, if the plurality of home devices 2a to 2e are connected to the master device 3 by using a communication network, the agent generation unit 36 automatically generates a plurality of home device agents 30a to 30e respectively corresponding to the plurality of home devices 2a to 2e. The control start signal, which is input by the user after connecting the plurality of home devices 2a to 2e to the master device 3, may be received first. If the home device agents 30a to 30e of the home devices 2a to 2e are being generated, the agent generation unit 36, which receives the agent input values X1a to X1e indicating profile information, changes information of the home device agents 30a to 30e based on the profile information (operation S5).

Likewise, after the home device agents 30a to 30e of all the home devices 2a to 2e are generated, an input of the state change information (input protocols Xa to Xe) from the plurality of home devices 2a to 2e is delayed.

Furthermore, if the agent input values X1a to X1e obtained by the input conversion unit 33 is state change information, the input conversion unit 33 transmits the agent input values X1a to X1e to the agent management unit 37 (operation S6).

When it is determined that the state change information (agent input value) is an optimization element (e.g., power consumption in the present exemplary embodiment) for an operation of the home device agents 30a to 30e (operation S7), the agent management unit 37 determines a pay value as a numerical value which increases as the pay value gets closer to the target value for an optimization element, and provides the pay value to the home device agents 30a to 30e to update the evaluation function of the home device agents 30a to 30e (operation S8).

When the state change information (agent input value) is information other than the optimization element (e.g., power consumption), the state change information is input to the home device agents 30a to 30e of all the home devices as a simple state change, and control commands Y1a to Y1e, which are issued in order to obtain optimal behavior, is obtained from the value function of each of the device agents 30a to 30e (operation S9). Furthermore, the control commands Y1a to Y1e for optimal behavior are transmitted to the output conversion unit 34.

The output conversion unit 34, which receives the control commands Y1a to Y1e, converts the control commands Y1a to Y1e into output protocols Ya to Ye indicating the optimal behavior of each of the plurality of home devices 2a to 2e by using the protocol analysis unit 35, and transmits the output protocols Ya to Ye to the communication protocol transmission unit 32 (operation S10).

The communication protocol transmission unit 32, which receives the output protocols Ya to Ye, transmits the output protocols Ya to Ye respectively corresponding to the plurality of home devices 2a to 2e (operation S11).

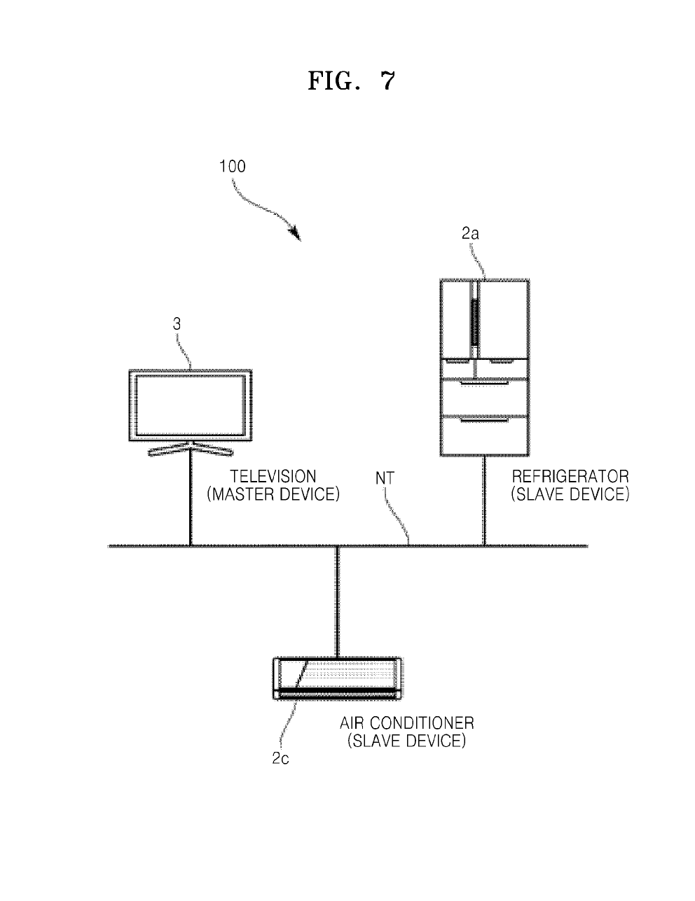

Thereafter, in the case where, for example, the refrigerator 2a and the air conditioner 2c, which are slave devices, are controlled by the master device 3 as simple models, the manner in which the master device 3 learns how to control the refrigerator 2a and the air conditioner 2c will be described with reference to FIGS. 7 to 10.

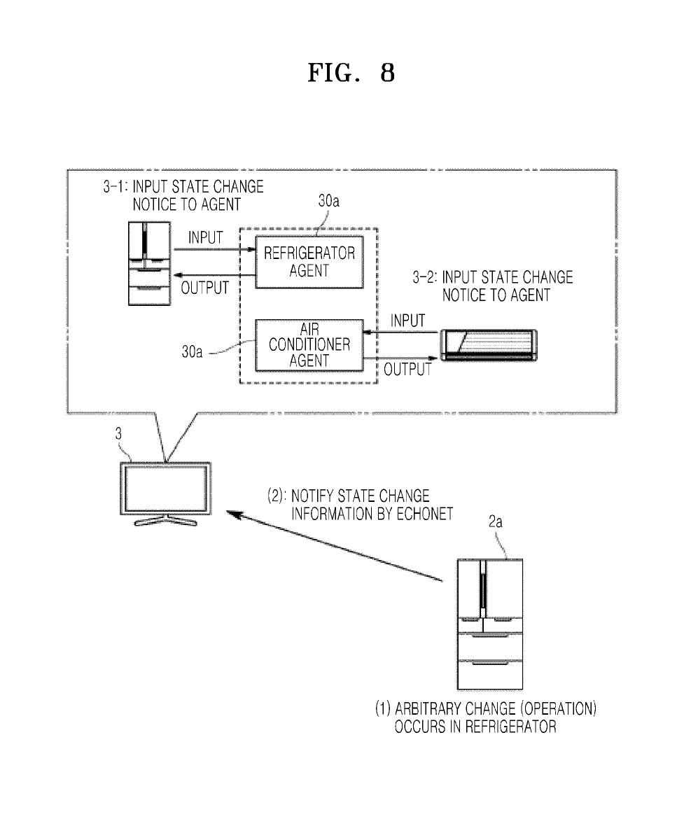

When an arbitrary state change (operation) occurs in the refrigerator 2a, which is a slave device, state change information indicating the state change is transmitted to the master device 3 via a communication protocol, e.g., Echonet, as illustrated in FIG. 8. The master device 3, which receives the state change information, inputs the state change information indicating the state change to the air conditioner agent 30c as well as to the refrigerator agent 30a.

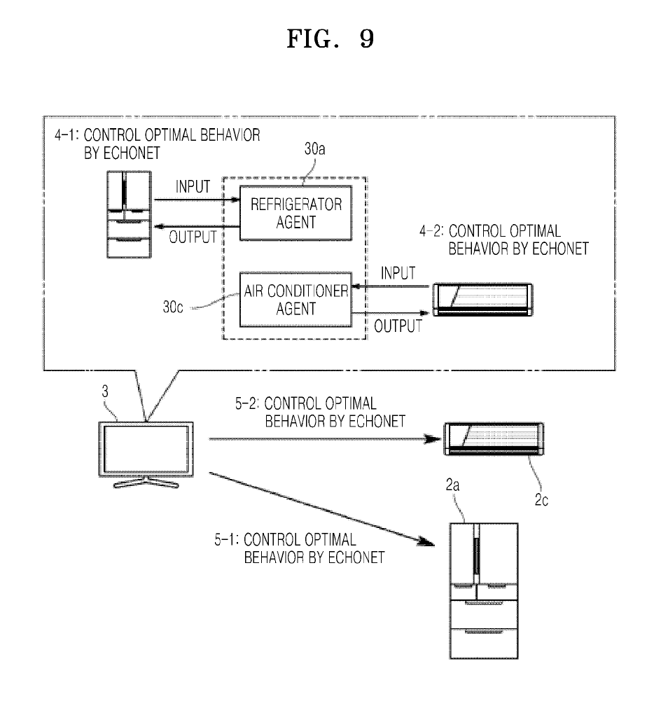

Then, as illustrated in FIG. 9, the control command indicating instructions necessary for achieving the optimal behavior is obtained by the refrigerator agent 30a and the air conditioner agent 30c, to which the state change information has been input. Furthermore, the master device 3 transmits the control command obtained from the refrigerator agent 30a to the refrigerator 2a via Echonet to control the refrigerator 2a, and transmits the control command obtained from the air conditioner agent 30c to the air conditioner 3c via Echonet to control the air conditioner 3c. It is understood that communication protocols other than Echonet may be used according to other exemplary embodiments.

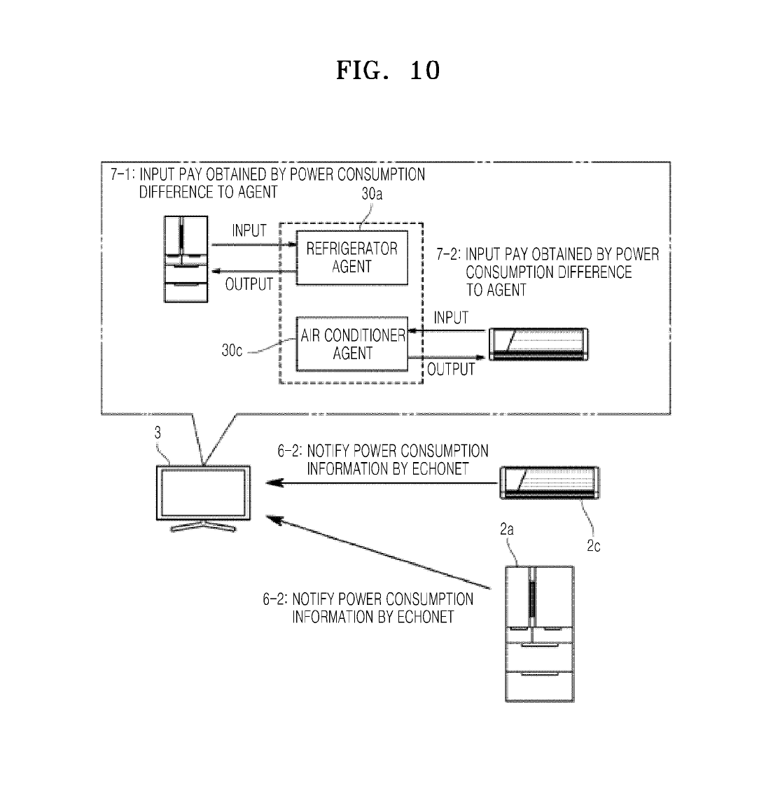

Thereafter, as illustrated in FIG. 10, the refrigerator 2a operates in response to the control command transmitted from the master device 3, and the resultant power consumption information of the refrigerator 2a is transmitted to the master device 3 via Echonet. Furthermore, the air conditioner 2c operates in response to the control command, and the resultant power consumption information of the air conditioner 2c is transmitted to the master device 3 via Echonet. The master device 3, which obtains the power consumption information, calculates pay values (a pay value for the refrigerator 2a and a pay value for the air conditioner 2c) using the power consumption difference obtained from the power consumption information, and updates the value function of the refrigerator 2a and the air conditioner 2c using the pay values (the pay value for the refrigerator 2a and the pay value for the air conditioner 2c) as the parameter. The power consumption difference is based on, for example, power consumption of refrigerator 2a before the control command and power consumption of refrigerator 2a after the control command. Based on the control command, the refrigerator 2a and the air conditioner 2c may be optimally controlled by using the reinforcement learning.

According to the present exemplary embodiment, the master device 3 has a plurality of home device agents 30a to 30e respectively corresponding to the plurality of home devices 2a to 2e, and the agent management unit 37 generates the control command by inputting device information obtained from the plurality of home devices 2a to 2e to the respective home device agents 30a to 30e. Thus, the master device 3 may learn how to autonomously control the plurality of home devices 2a to 2e in a distributed manner and, at the same time, the plurality of home devices 2a to 2e may be effectively controlled by resolving the inconvenience according to the extraction of a sensor associated with each home device.

Furthermore, the agent management unit 37 calculates the pay value according to the state variation obtained from the plurality of home devices 2a to 2e and updates the value function of the plurality of home device agents 30a to 30e by using the pay value as a parameter, and thus, learning in an environment in which the initial states of the home devices 2a to 2e are unknown is possible and each home device 2a to 2e may be optimally operated.

Furthermore, since the master device 3 includes the plurality of home device agents 30a to 30e respectively corresponding to the plurality of home devices 2a to 2e, some agents may be easily moved to another master device and a high fault tolerance is guaranteed.

Furthermore, although only home device agents 30a to 30e corresponding to home devices 2a to 2e are illustrated as being generated by the agent generation unit 36, the exemplary embodiments are not limited thereto, and additional home device agents may be generated by the agent generation unit 36 depending on the number of home devices connected to the communication network.

Furthermore, since the master device is implemented as one of the home devices, such as, for example, a television or a BD recorder, it is not necessary to provide a control device for controlling device separately.

Furthermore, other exemplary embodiments are not limited to the above exemplary embodiment.

For example, in the above exemplary embodiment, a plurality of home device agents are formed within the virtual space within the internal memory of the master device 3, but the plurality of home device agents may be distributed and formed in the plurality of master devices. As such, the fault tolerance of the home network system may be further improved.

As described above, a home network system according to the one or more of the above exemplary embodiments may control a plurality of home devices autonomously and in a distributed manner, enable optimal control of a plurality of home devices by resolving inconvenience according to extraction of a sensor associated with each home device, and easily move a virtual model of a home device from one master device to another master device.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the exemplary embodiments as defined by the following claims.

What is claimed is:

1. A home network control apparatus configured to control a plurality of home devices, the home network control apparatus comprising:
a plurality of home device agents respectively corresponding to the plurality of home devices; and
an agent manager which is configured to transmit device information obtained from the plurality of home devices to each of the plurality of home device agents, output a control command obtained from the plurality of home device agents to the plurality of home devices, calculate a pay value according to a state variation obtained from the plurality of home devices, the state variation being based on the device information, and update a value function of the plurality of home device agents by using the pay value as a parameter, the value function being used to generate the control command.

2. The home network control apparatus of claim 1, further comprising:
an agent generator configured to generate the plurality of home device agents respectively corresponding to the plurality of home devices by using profile information of the plurality of respective home devices.

3. The home network control apparatus of claim 1, wherein the agent manager is configured to calculate the pay value by using a power consumption difference as the state variation obtained from the plurality of home devices, and update the value function of the plurality of home device agents to minimize power consumption in the plurality of home devices by using the pay value as a parameter.

4. A home network system connected to a plurality of home devices which implement respective standardized protocols via a communication network, the home network system comprising:
a master device which controls the plurality of home devices, wherein the master device comprises:
a plurality of home device agents respectively corresponding to the plurality of home devices; and
an agent manager which is configured to transmit device information obtained from the plurality of home devices to each of the plurality of home device agents, output a control command obtained from the plurality of home device agents to the plurality of home devices, calculate a pay value according to a state variation obtained from the plurality of home devices, the state variation being based on the device information, and update a value function of the plurality of home device agents by using the pay value as a parameter, the value function being used to generate the control command.

5. The home network system of claim 4, further comprising:
an agent generator configured to generate the plurality of home device agents respectively corresponding to the plurality of home devices by using profile information of the plurality of respective home devices.

6. The home network system of claim 4, wherein the agent manager is configured to calculate the pay value by using a power consumption difference as the state variation obtained from the plurality of home devices, and update the value function of the plurality of home device agents to minimize power consumption in the plurality of home devices by using the pay value as a parameter.

7. The home network system of claim 1, wherein the master device is implemented as one of the plurality of home devices.

8. A non-transitory computer readable recording medium having recorded thereon a home device control program which is connected to a plurality of home devices which implement respective standardized protocols and is used in a home network system including a master device that controls the plurality of home devices, the home device control program comprising:
a plurality of home device agents respectively corresponding to the plurality of home devices; and
an agent manager which is configured to transmit device information obtained from the plurality of home devices to each of the plurality of home device agents, output a control command obtained from the plurality of home device agents to the plurality of home devices, calculate a pay value according to a state variation obtained from the plurality of home devices, the state variation being based on the device information, and update a value function of the plurality of home device agents by using the pay value as a parameter, the value function being used to generate the control command.

9. The home network control apparatus of claim 1, wherein the control command comprises instructions to obtain optimal behavior of the home devices.

10. The home network system of claim 4, wherein the control command comprises instructions to obtain optimal behavior of the home devices.

11. A method of controlling a plurality of home devices by a master device, the method comprising:
obtaining information from each of the plurality of home devices;
determining, for each home device, whether the information is profile information for the respective home device; and
selectively updating, for each home device, a home device agent comprising an analysis model corresponding to the respective home device, which is stored within an internal memory of the master device, according to the determining.

12. The method of claim 11, wherein the selectively updating comprises:
updating, for a given home device, the home device agent corresponding to the given home device in response to determining that the information for the given home device is profile information for the given home device; and
not updating, for the given home device, the home device agent corresponding to the given home device in response to determining that the information for the given home device is not profile information for the given home device.

13. The method of claim 11, further comprising:
in response to determining that the information for a given home device is profile information for the given home device, determining whether the profile information for the given home device is an optimization element; and
in response to determining that the profile information for the given home device is the optimization element, updating a value function used by the home device agent corresponding to the given home device to adjust control commands output to the given home device.

14. The method of claim 13, further comprising:
in response to determining that the information for the given home device is not profile information for the given home device, updating the home device agent corresponding to the given home device based on the information.

15. The method of claim 11, wherein each of the home devices communicate with the master device via a respective standardized protocol.

16. The method of claim 15, wherein the respective standardized protocols comprise at least one of Echonet, Zigbee, and UPnP.

17. The method of claim 16, wherein the home devices are respectively implemented as one of a television, a refrigerator, an optical disc reproducing apparatus, an air conditioner, a washing machine, and a microwave oven.

18. The method of claim 17, wherein the master device is implemented as one of the home devices.
